(19) United States
(12) Patent Application Publication
(10) Pub. No.: US 2017/0015878 A1
(43) Pub. Date: Jan. 19, 2017

(54) ADHESIVE COMPOSITION CONTAINING IONIC ANTISTATIC AGENT

(71) Applicant: DONGWOO FINE-CHEM CO., LTD., Jeollabuk-do (KR)

(72) Inventor: Han Young CHOI, Gyeonggi-do (KR)

(21) Appl. No.: 15/281,218

(22) Filed: Sep. 30, 2016

Related U.S. Application Data
(63) Continuation of application No. PCT/KR2015/002611, filed on Mar. 18, 2015.

(30) Foreign Application Priority Data
Apr. 4, 2014 (KR) 10-2014-0040476

(51) Int. Cl. C09J 133/06; B32B 7/12; C09J 11/06; C09J 7/00; C09J 9/00

(52) U.S. Cl. CPC C09J 133/066; C09J 7/00; C09J 9/00; C09J 11/06; B32B 7/12; C08K 5/3445

(57) ABSTRACT

An adhesive composition includes an acryl copolymer, a cross-linking agent, and an ionic antistatic agent represented by Formula 1, thereby exhibiting excellent antistatic property, as well as, significantly improved durability, maintaining excellent adhesiveness under severe conditions such as high temperature and high humidity atmospheres, and securing sufficient antistatic property even if used in a small amount.

### CROSS-REFERENCE TO RELATED APPLICATIONS

The present application is a continuation application to International Application No. PCT/KR2015/002611, with an International Filing Date of Mar. 18, 2015, which claims the benefit of Korean Patent Application No. 10-2014-0040476, filed in the Korean Intellectual Property Office on Apr. 4, 2014, the entire contents of which are incorporated herein by reference.

### BACKGROUND OF THE INVENTION

1. Field of the Invention

The present invention relates to an adhesive composition including an ionic antistatic agent.

2. Description of the Related Art

A liquid crystal display device includes liquid crystal cells containing liquid crystals and a polarizing plate, and the liquid crystal cells and the polarizing plate are mostly bonded to each other by an adhesive layer formed on one surface of the polarizing plate. Other than the above components, in order to improve performance of the liquid crystal display device, surface protective films such as a retardation plate, a wide viewing angle compensation plate, or the like is additionally attached to the polarizing plate by an adhesive to be used.

Since optical members such as the surface protective film and the polarizing plate are made of plastic materials, static electricity is generated during rubbing or peeling-off the surface protective film. In this case, when voltage is applied to the liquid crystals in a state of residual static electricity, defects may occur in a liquid crystal panel or orientation of the liquid crystal molecules may be damaged. Therefore, in order to prevent such problems, a variety of antistatic treatments have been currently executed.

For example, when adding an antistatic agent including polyether polyol and an alkaline metal salt to an acryl adhesive, bleeding of an antistatic agent occurs to considerably reduce durability after curing the adhesive. When applying it to the protective film, bleed-out easily occurs under high temperature conditions to cause a problem of polluting a subject to be adhered.

Further, there is a method for performing an antistatic function by adding at least one surfactant to an adhesive and transferring the surfactant to a subject to be adhered. However, this method has a problem of easily bleeding the surfactant on the surface of the adhesive. When this method is applied to a protective film, it may encounter a problem of polluting the subject to be adhered.

Korean Patent Laid-Open Publication No. 2010-0016163 discloses an antistatic optically clear pressure sensitive adhesive composition for preventing static electricity, and uses an antistatic agent including fluorine-containing organic salts of ionic salts. However, the patent has a problem that an excessive amount of antistatic agent is required in order to secure sufficient antistatic property.

In addition, Korean Patent Laid-Open Publication No. 2011-0136760 discloses a method of introducing a functional group having an excellent compatibility with an antistatic agent into a monomer of an adhesive composition in order to suppress bleeding of the antistatic agent. However, the patent has not solved the problem of causing deterioration in durability under hot and humid conditions.

SUMMARY Accordingly, it is an object of the present invention to provide an adhesive composition including an ionic antistatic agent capable of exhibiting required antistatic property even if used in a small amount due to significantly improved antistatic property while maintaining excellent durability. The above object of the present invention will be achieved by the following characteristics:

(1) An adhesive composition comprising an acryl copolymer, a cross-linking agent, and an ionic antistatic agent represented by Formula 1 below:

Y^{⊕}F₃C—BF₃^{\textcircled{-}} [Formula 1]

(wherein, Y+ is an alkaline metal cation, ammonium, imidazolium, pyridinium, phosphonium, sulfonium or sulfoxonium).

(2) The adhesive composition according to the above (1), wherein the ionic antistatic agent represented by Formula 1 is at least one selected from a group consisting of Formulae 2 to 10 below:

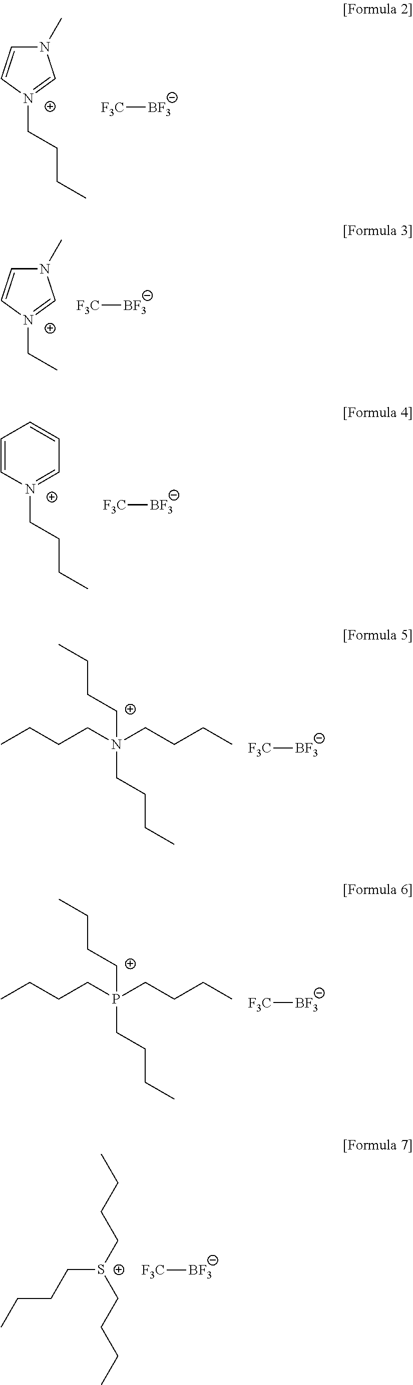

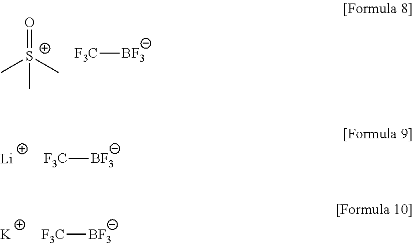

(3) The adhesive composition according to the above (1), wherein the ionic antistatic agent is included in an amount of 0.1 to 10 parts by weight to 100 parts by weight of the acryl copolymer in terms of solid content.

(4) The adhesive composition according to the above (1), wherein the ionic antistatic agent is included in an amount of 0.5 to 5 parts by weight to 100 parts by weight of the acryl copolymer in terms of solid content.

(5) An adhesive sheet comprising an adhesive layer formed of the adhesive composition according to the above (1) to (4).

(6) A polarizing plate comprising an adhesive layer formed of the adhesive composition according to the above (1) to (4) on at least one surface thereof. (7) An image display device comprising the polarizing plate according to the above (6).

The adhesive composition includes an antistatic agent having anion of a specific structure containing boron, thus it has high stability of anion and improved degree of freedom with regard to the movement of cation, thereby exhibiting excellent antistatic property even if used in a small amount, and having excellent compatibility with the adhesive composition, such that it is possible to provide an adhesive composition with excellent durability due to suppressing bleeding out of ionic compound.

### DETAILED DESCRIPTION

The present invention discloses an adhesive composition including an acryl copolymer, a cross-linking agent, and an ionic antistatic agent, thereby exhibiting excellent antistatic property, as well as, significantly improved durability, maintaining excellent adhesiveness under severe conditions such as high temperature and high humidity atmospheres, and securing sufficient antistatic property even if used in a small amount.

Hereinafter, the present invention will be described in detail.

<Adhesive Composition>

The adhesive composition of the present invention includes an acryl copolymer, a cross-linking agent, and an ionic antistatic agent.

The ionic antistatic agent of the present invention is represented by Formula 1 below, and includes inorganic anions of a specific structure as below, thus it has high stability of anion and improved degree of freedom with regard to the movement of cation, thereby significantly improving antistatic property. Therefore, even if the antistatic agent of the present invention is used in a small amount, it is possible to exhibit excellent antistatic property. In addition, the antistatic agent of the present invention has excellent compatibility with the adhesive composition, such that it is possible to exhibit the same or better effect in terms of durability than a case using the conventional antistatic agent under high temperature and high humidity conditions.

Y^{⊕}F₃C—BF₃^{\textcircled{-}} [Formula 1]

(wherein, Y+ is an alkaline metal cation, ammonium, imidazolium, pyridinium, phosphonium, sulfonium or sulfoxonium).

In the present invention, when the Y+ is ammonium, imidazolium, pyridinium, phosphonium, sulfonium or sulfoxonium, it may include ammonium, imidazolium, pyridinium, phosphonium, sulfonium or sulfoxonium, which is not substituted, as well as, ammonium, imidazolium, pyridinium, phosphonium, sulfonium or sulfoxonium, which is substituted with aliphatic hydrocarbon or aromatic hydrocarbon. For example, the Y+ may be ammonium, imidazolium, pyridinium, phosphonium, sulfonium or sulfoxonium, which is substituted with an alkyl group having 1 to 12 carbon atoms.

Particular examples of the ionic antistatic agent according to the present invention may be at least one selected from a group consisting of Formulae 2 to 10 below:

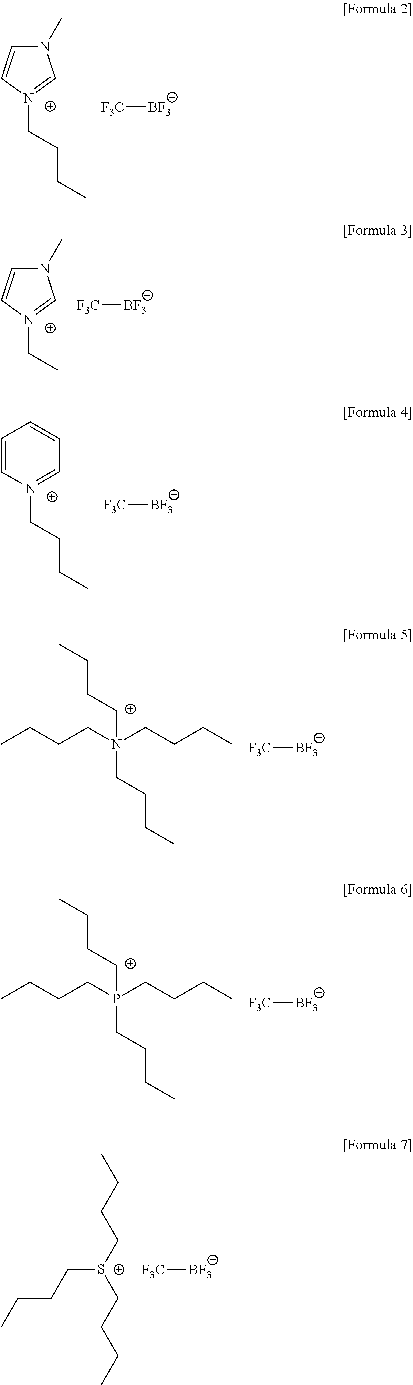

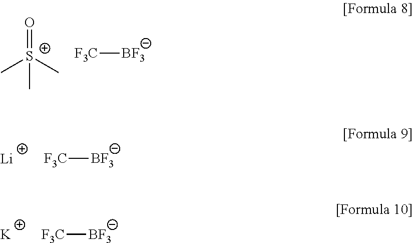

A content of the ionic antistatic agent is not particularly limited but may be included, for example, in an amount of 0.1 to 10 parts by weight ('wt. parts') to 100 wt. parts of the acryl copolymer, and for example, 0.5 to 5 wt. parts. If the content thereof is less than 0.1 wt. parts, antistatic property may be insignificant. Meanwhile, if the content thereof exceeds 10 wt. parts, bleeding out may easily occur, to cause peeling-off damages under heat resistant conditions.

The acryl copolymer of the present invention may include a compound polymerized while including (meth)acrylate monomer containing an alkyl group with 1 to 12 carbon atoms and a polymerizable monomer having a cross-linkable functional group. Herein, (meth)acrylate means both of acrylate and methacrylate.

The (meth)acrylate monomer having an alkyl group with 1 to 12 carbon atoms may include, for example, n-butyl(meth)acrylate, 2-butyl(meth)acrylate, t-butyl(meth)acrylate, 2-ethylhexyl(meth)acrylate, ethyl(meth)acrylate, methyl(meth)acrylate, n-propyl(meth)acrylate, isopropyl(meth)acrylate, pentyl(meth)acrylate, n-octyl(meth)acrylate, isooctyl(meth)acrylate, nonyl(meth)acrylate, decyl(meth)acrylate, lauryl(meth)acrylate, or the like. Among these, n-butyl acrylate, 2-ethylhexylacrylate or a mixture thereof may be used. These compound may be used alone or in combination of two or more thereof.

A content and mixing ratio of the (meth)acrylate monomer having an alkyl group with 1 to 12 carbon atoms are not particularly limited but may be included, for example, in an amount of 85 to 99.9 wt. parts, and for another example, 90 to 95 wt. parts to 100 wt. parts of whole monomers in terms of solid content. If the content thereof is less than 85 wt. parts, desired adhesiveness cannot be sufficiently expressed. Meanwhile, if the content thereof exceeds 99.9 wt. parts, cohesiveness may be reduced.

The polymerizable monomer having a cross-linkable functional group is a component of reinforcing cohesiveness or adhesive strength of the adhesive composition through a chemical bond to thus provide durability and cutting ability. For example, the polymerizable monomer may include a monomer having a carboxyl group, a monomer having a hydroxyl group, a monomer having an amide group, a monomer having a tertiary amine group, or the like. These materials may be used alone or in combination of two or more thereof. In an aspect of improvement in anti-corrosive property, it is preferable not to include acrylic acid.

The monomer having a carboxyl group may include, for example: mono-valent acids such as (meth)acrylic acid, crotonic acid, etc.; di-valent acids such as maleic acid, itaconic acid, fumaric acid, etc. and monoalkylesters thereof; 3-(meth)acryloylpropionic acid; a ring-opening adduct of succinic anhydride of 2-hydroxyalkyl (meth)acrylate having an alkyl group with 2 to 3 carbon atoms, a ring-opening adduct of succinic anhydride of hydroxylalkyleneglycol (meth)acrylate having an alkylene group with 2 to 4 carbon atoms, a compound prepared by ring-opening addition of succinic anhydride to a caprolactone adduct of 2-hydroxyalkyl (meth)acrylate having an alkyl group with 2 to 3 carbon atoms, or the like. Among these, (meth)acrylic acid may be used.

The monomer having a hydroxyl group may include, for example, 2-hydroxyethyl (meth) acrylate, 2-hydroxypropyl (meth) acrylate, 2-hydroxybutyl (meth) acrylate, 4-hydroxybutyl (meth)acrylate, 6-hydroxylhexyl (meth)acrylate, 2-hydroxyethyleneglycol (meth) acrylate, 2-hydroxylpropyleneglycol (meth)acrylate, hydroxylalkyleneglycol (meth)acrylate having an alkylene group with 2 to 4 carbon atoms, 4-hydroxybutylvinylether, 5-hydroxypentylvinylether, 6-hydroxyhexylvinylether, 7-hydroxyheptylvinylether, 8-hydroxyoctylvinylether, 9-hydroxynonylvinylether, 10-hydroxydecylvinylether, or the like. Among these, 4-hydroxybutylvinylether may be used. The monomer having an amide group may include, for example, (meth)acrylamide, N-isopropyl acrylamide, N-tert-butyl acrylamide, 3-hydroxypropyl (meth) acrylamide, 4-hydroxybutyl (meth) acrylamide, 6-hydroxyhexyl (meth) acrylamide, 8-hydroxyoctyl (meth) acrylamide, 2-hydroxyethylhexyl (meth)acrylamide, or the like. Among these, (meth)acrylamide may be used.

The monomer having a tertiary amine group may include, for example, N,N-(dimethylamino)ethyl (meth)acrylate, N,N-(diethylamino) ethyl (meth) acrylate, N,N-(dimethylamino)propyl (meth)acrylate, or the like.

A content and mixing ratio of the monomer having a cross-linkable functional group are not particularly limited but may be included, for example, in an amount of 0.1 to 15 wt. parts, and more particularly, 0.5 to 8 wt. parts to 100 wt. parts of whole monomers in terms of solid content. If the content thereof is less than 0.1 wt. part, the adhesive may have decreased cohesiveness to reduce durability. While, if the content thereof exceeds 15 wt. parts, adhesiveness is decreased due to a high gel fraction to hence reduction in durability.

In addition to the above monomers, the acryl copolymer may further include a typical and polymerizable monomer known in the related art within a range with no deterioration in adhesiveness, for example, in a content of 10 wt. % or less to a total weight of whole monomers.

Methods for preparation of a copolymer are not particularly limited but the copolymer may be prepared by any conventional polymerization method such as bulk polymerization, solution polymerization, emulsion polymerization or suspension polymerization. Solution polymerization may be used. Further, solvents, polymerization initiators, chain transfer agents for controlling a molecular weight, or the like, generally used in the polymerization, may also be included.

The acryl copolymer may have a weight average molecular weight (in terms of polystyrene, Mw) measured by gel permeation chromatography (GPC) of 50,000 to 2,000,000, and for example, 400,000 to 2,000,000. If the molecular weight is less than 50,000, cohesiveness between copolymers is insufficient to cause a problem in adhesive durability. While, if the molecular weight exceeds 2,000,000, it may need a great amount of diluted solvent in order to ensure desired workability during coating.

The cross-linking agent is an ingredient for appropriately cross-linking the copolymer to reinforce cohesiveness of the adhesive. Types thereof are not particularly limited and may use, for example, an isocyanate-based cross-linking agent, an epoxy-based cross-linking agent, or the like, which may be used alone or in combination of two or more thereof.

The isocyanate-based cross-linking agent may include, for example: diisocyanate compounds such as tolylene diisocyanate, xylene diisocyanate, 2,4-diphenymethane diisocyanate, 4,4-diphenylmethane diisocyanate, hexamethylene diisocyanate, isophorone diisocyanate, tetramethylene xylene diisocyanate, naphthalene diisocyanate, etc.; adducts of polyalcohol compounds such as diisocyanate and trimethylolpropane diisocyanate, etc.;

self-condensed isocyanurates of diisocyanate; burette body obtained by condensing diisocyanate on diisocyanate urea; polyfunctional isocyanate compounds having three functional groups such as triphenylmethane triisocyanate, methylenebistriisocyanate, etc., or the like.

The epoxy-based cross-linking agent may include, for example, ethyleneglycol diglycidylether, diethyleneglycol diglycidylether, polyethyleneglycol diglycidylether, propyleneglycol diglycidylether, tripropyleneglycol diglycidylether, polypropyleneglycol diglycidylether, neopentylglycol diglydicylether, 1,6-hexanediol diglycidylether, polytetramethyleneglycol diglycidylether, glycerol diglycidylether, glycerol triglycidylether, diglycerol polyglycidylether, polyglycerol polyglycideylether, resorcine diglycidylether, 2,2-dibromoneopentylglycol diglycidylether, trimethylolpropane glycidylether, pentaerythritol polyglycidylether, sorbitol polyglycidylether, adipic acid glycidylester, phthalic acid glycidylester, tris(glycidyl)isocyanurate, tris(glycidoxyethyl)isocyanurate, 1,3-bis(N,N-glycidylaminomethyl)cyclohexane, N,N,N′,N′-tetraglycidyl-m-xylyldiamine, or the like.

Further, at least one cross-linking agent selected from a group consisting of melamine derivatives, for example, hexamethylol melamine, hexamethoxymethyl melamine, hexabutoxymethyl melamine, or the like, may be further added to the above isocyanate-based cross-linking agents and used together.

An example of the cross-linking agent commercially available in the market may be Cor-L (Nippon Polyurethane Industry Co., Ltd.).

A content of the cross-linking agent is not particularly limited so far as it can fully express functions thereof but may include, for example, in a range of 0.1 to 15 wt. parts, and more particularly, 0.1 to 5 wt. parts to 100 wt. parts of the acryl copolymer. If the content thereof is less than 0.1 wt. parts, cohesiveness decreases due to lack of cross-linking degree, and may deteriorate physical properties such as adhesive durability and cutting ability. While, if the content thereof exceeds 15 wt. parts, there may occur a problem in mitigating residual stress due to excess cross-linking reaction. The adhesive composition of the present invention may further include a silane coupling agent.

The silane coupling agent may covalently bond with a polar group on the surface of a subject to be adhered to improve adhesiveness.

The silane coupling agent is not particularly limited if it contains a functional group such as amino, epoxy, acetoacetyl, polyalkyleneglycol, acryl or alkyl group. For example, vinyl trimethoxysilane, vinyl triethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethoxyldimethoxysilane, 3-chloropropyltrimethoxysilane, 3-methacryloxypropyltrimethoxysilane, 3-mercaptopropyltrimethoxysilane, 3-glycidoxypropyltriethoxysilane, 3-glycidoxypropyldimethoxymethylsilane, 3-glycidoxypropylethoxydimethylsilane, or the like, which are used alone or in combination of two or more thereof.

A particular example of the silane coupling agent commercially available in the market may be KBM-403 (Shinetsu Co.).

A content of the silane coupling agent is not particularly limited but may be included, for example, in an amount of 0.1 to 2 wt. parts, and more particularly, 0.1 to 0.5 wt. part to 100 wt. parts of acryl copolymer, in terms of solid content. If the content thereof is less than 0.1 wt. part, adhesion to a substrate is not sufficient to cause exfoliation under heat and moist resistant conditions. Meanwhile, if the content thereof exceeds 2 wt. parts, cohesiveness is increased too high and may decrease adhesive properties such as adhesiveness to hence cause reduction in durability. Other than the foregoing various components, the adhesive composition of the present invention may further include different additives generally used in the related art, i.e., an antioxidant, a corrosion-resistant agent, a defoaming agent, a filler, a leveling agent, or the like, within a range not departing from the purpose of the present invention.

<Adhesive Sheet>

Further, the present invention provides an adhesive sheet including an adhesive layer formed of the adhesive composition.

A thickness of the adhesive layer is not particularly limited but may range, for example, from 3 to 100 μm, and more particularly, 10 to 100 μm.

The adhesive sheet of the present invention may include an adhesive layer formed on at least one surface of a release film.

The adhesive layer may be formed by coating the at least one surface of the release film with the adhesive composition. A coating method is not particularly limited but may include any conventional method known in the related art. For example, bar coater, air knife, gravure, reverse roll, kiss roll, spray, blade, die coater, casting, spin coating, or the like may be employed.

The release film is not particularly limited but may include any conventional release film used in the related art. For example, polyester resin such as polyethylene terephthalate, polybutylene terephthalate, polyethylene naphthalate, polybutylene naphthalate, etc.; polyimide resin; acryl resin; styrene resin such as polystyrene and acrylonitrile-styrene; polycarbonate resin; polylactic acid resin; polyurethane resin; polyolefin resin such as polyethylene, polypropylene, ethylene-propylene copolymer; vinyl resin such as polyvinyl chloride, polyvinylidene chloride, etc.; sulfone resin; polyether-ether ketone resin; allylate resin; or a mixture thereof may be used.

A thickness of the release film is not particularly limited but may range, for example, from 5 to 500 μm, and more particularly, 10 to 100 μm.

<Polarizing Plate>

Further, the present invention provides a polarizing plate including an adhesive layer formed of the adhesive composition on at least one surface thereof.

The polarizing plate of the present invention may include a polarizer, a protective film adhered to at least one surface of the polarizer, and an adhesive layer formed of the adhesive composition on the protective film.

The polarizer may be any polarizer known in the related art, and for example, prepared by a process such as swelling, dying, cross-linking, drawing, washing, drying a polyvinyl alcohol film, or the like.

The protective film used herein is not particularly limited so far as the film has excellent properties such as transparency, mechanical strength, thermal stability, moisture-shielding properties, isotropic properties, or the like. In particular, polyester films such as polyethylene terephthalate, polyethylene isophthalate, polybutylene terephthalate, etc.; cellulose films such as diacetylocellulose, triacetylcellulose, etc.; polycarbonate films; acryl films such as polymethyl (meth)acrylate, polyethyl (meth)acrylate, etc.; styrene films such as polystyrene, acrylonitrile-styrene copolymer, etc.; polyolefin films; vinyl chloride films; polyamide films such as nylon, aromatic polyamide, etc.; imide films; sulfone films;

polyetherketone films; polyphenylene sulfide films; vinyl alcohol films; vinylidene chloride films; vinyl butyral films; allylate films; polyoxymethylene films; urethane films; epoxy films; silicon films, or the like, may be used. In particular, the cellulose film having a surface saponified using alkali or the like may be used among the above compounds, in consideration of polar properties or durability. The protective film may further have the function of an optical layer.

The adhesive layer may be directly applied to the protective film, or formed by attaching an adhesive sheet to the protective film. A thickness thereof may be controlled according to adhesiveness, and typically, is 3 to 100 μm, and for example, 10 to 100 μm.

<Image Display Device>

Further, the present invention provides an image display device including the above-described polarizing plate.

The image display device of the present invention may further include any conventionally known configurations in addition to the above polarizing plate.

Hereinafter, exemplary embodiments are proposed to more concretely describe the present invention. However, the following examples are only given for illustrating the present invention and those skilled in the art will obviously understand that these examples do not restrict the appended claims but various alterations and modifications are possible within the scope and spirit of the present invention. Such alterations and modifications are duly included in the appended claims.

### Preparative Example 1

### Preparation of Acryl Copolymer

A monomer mixture including 90 wt. parts of n-butyl acrylate, 7 wt. parts of methacrylate, 2 wt. parts of 2-hydroxyethyl acrylate and 1 wt. parts of acrylic acid was introduced into 1 L reactor equipped with a cooling device for easy control of temperature, in which a nitrogen gas is refluxed. Then, a solvent, that is, 100 wt. parts of ethyl acetate (EAc) was added thereto. Next, after purging the nitrogen gas for 1 hour in order to remove oxygen, the mixture was maintained at 62° C. After homogenizing the mixture, 0.07 wt. parts of a reaction initiator, that is, azobisisobutyronitrile (AIBN) was introduced into the reactor, followed by a reaction for 8 hours to prepare an acryl copolymer (with a weight average molecular weight of about 1,000,000).

### EXAMPLE

### (1) Preparation of Adhesive Composition

Adhesive compositions having constitutional compositions and contents listed in Table 1 below were prepared.

### (2) Formation of Adhesive Sheet

After preparing each of the adhesive compositions, it was applied to a film coated with a silicon release agent, followed by drying at 100° C. for 1 minute to form an adhesive layer having a thickness of 25 μm.

Then, the release film was laminated on the above adhesive layer, to prepare an adhesive sheet.

### (3) Fabrication of Adhesive-Adhered Polarizing Plate

After peeling-off the release film from the produced adhesive sheet, the adhesive layer was laminated on an iodine-based polarizing plate provided with TAC protective film having a thickness of 185 μm, to thus fabricate a polarizing plate including the adhesive adhered thereto.

TABLE 1

| | | | | Cross- | Silane |
|---|---|---|---|---|---|
| | Polyaminoether | | Acryl | linking | coupling |
| Section | compound | | copolymer | agent | agent |
| (wt. part) | (A) | | (B) | (C) | (D) |
| Example 1 | A-1 | 1 | 100 | 1 | 0.5 |
| Example 2 | A-2 | 1.5 | 100 | 1 | 0.5 |
| Example 3 | A-3 | 1 | 100 | 1 | 0.5 |
| Example 4 | A-4 | 1 | 100 | 1 | 0.5 |
| Example 5 | A-5 | 1 | 100 | 1 | 0.5 |
| Example 6 | A-6 | 1.5 | 100 | 1 | 0.5 |
| Example 7 | A-7 | 2.0 | 100 | 1 | 0.5 |
| Example 8 | A-8 | 1 | 100 | 1 | 0.5 |
| Example 9 | A-9 | 1 | 100 | 1 | 0.5 |
| Example 10 | A-1 | 6 | 100 | 1 | 0.5 |
| Example 11 | A-1 | 12 | 100 | 1 | 0.5 |
| Comparative | A-10 | 1 | 100 | 1 | 0.5 |
| Example 1 | | | | | |
| Comparative | A-11 | 1 | 100 | 1 | 0.5 |
| Example 2 | | | | | |
| Comparative | A-12 | 1 | 100 | 1 | 0.5 |
| Example 3 | | | | | |
| Comparative | A-13 | 1 | 100 | 1 | 0.5 |
| Example 4 | | | | | |
| Comparative | A-14 | 1 | 100 | 1 | 0.5 |
| Example 5 | | | | | |
| Comparative | A-15 | 1 | 100 | 1 | 0.5 |
| Example 6 | | | | | |

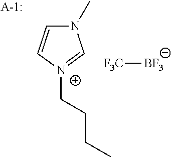

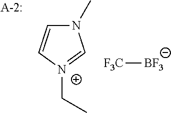

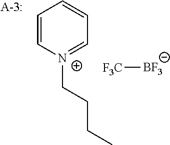

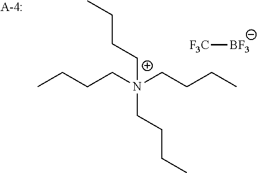

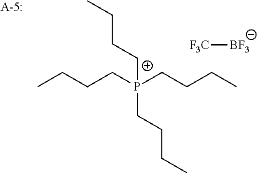

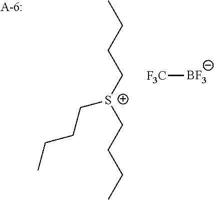

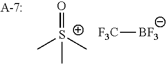

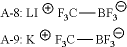

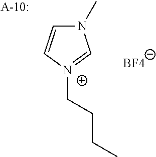

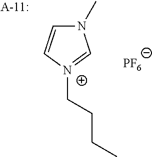

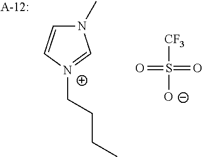

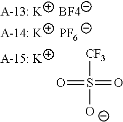

B: acryl copolymer according to Preparative Example 1
C: Cor-L (Nippon Polyurethane Industry Co. Ltd.)
D: KBM-403 (Shinetsu Co.)

### Experimental Example

Each of the adhesive compositions prepared in the examples and comparative examples was applied to the release film coated with a silicon releasing agent to reach a thickness after curing of 25 μm, then, dried at 100° C. for 1 minute to form an adhesive layer.

Thereafter, the formed adhesive layer was laminated on an iodine polarizing film having triacetyl cellulose protective films adhered at both sides thereof (total thickness of 185 μm) by a bonding process to thus fabricate a polarizing plate. The fabricated polarizing plate was stored at 23° C. under a condition of 60% RH for 7 days.

(1) Evaluation of Heat Resistance

After removing the release film from the fabricated polarizing plate, the plate was adhered to a corning glass, followed by autoclave treatment. Then, after leaving the product at 60° C. for 300 hours, occurrence of bubbles of exfoliation was observed and evaluated. Evaluation was performed after heat treating and then leaving the product at room temperature for 24 hours just before evaluating.

<Standards for Evaluation>

⊚: any bubble or exfoliation was not visually confirmed

◯: 2 or 5 bubbles or exfoliations were observed

Δ: 5 to 10 bubbles or exfoliations were observed

x: 10 or more bubbling and exfoliation were observed

(2) Evaluation of Antistatic Property

A surface specific resistance of the fabricated polarizing plate was measured (unit: Ω·cm)

<Standards for Evaluation>

⊚: when the surface specific resistance value is less than 1.0×10¹¹

◯: when the surface specific resistance value is 1.0×10¹¹ or more but less than 5.0×10¹¹

Δ: when the surface specific resistance value is 5.0×10¹¹ or more but less than 1×10¹²

x: when the surface specific resistance value is 1.0×10¹² or more

TABLE 2

| Section | Heat Resistance | Antistatic Property |
|---|---|---|
| Example 1 | ⊚ | ⊚ |
| Example 2 | ⊚ | ⊚ |
| Example 3 | ⊚ | ◯ |
| Example 4 | ⊚ | ◯ |
| Example 5 | ⊚ | ◯ |
| Example 6 | ⊚ | ⊚ |
| Example 7 | ⊚ | ⊚ |
| Example 8 | ⊚ | ⊚ |
| Example 9 | ⊚ | ⊚ |
| Example 10 | ◯ | ⊚ |
| Example 11 | Δ | ⊚ |
| Comparative | Δ | Δ |
| Example 1 | | |
| Comparative | Δ | Δ |
| Example 2 | | |
| Comparative | Δ | Δ |
| Example 3 | | |
| Comparative | X | Δ |
| Example 4 | | |
| Comparative | X | Δ |
| Example 5 | | |
| Comparative | X | Δ |
| Example 6 | | |

As understood in Table 2, it could be seen that the adhesive composition using the novel ionic antistatic agent exhibited excellent antistatic property and high heat resistance to thus not easily occur exfoliation even under high temperature and humidity conditions.

However, Example 11 using an excess of antistatic agent demonstrated a little reduced heat resistance only.

On the other hand, it could be seen that the adhesive compositions of the comparative examples had significantly deteriorated high heat resistance and antistatic property as a whole compared to those of examples.

What is claimed is:

1. An adhesive composition comprising:
an acryl copolymer;
a cross-linking agent; and
an ionic antistatic agent represented by Formula 1:
Y^{⊕}F₃C—BF₃^{\textcircled{-}} [Formula 1]
wherein, Y+ is an alkaline metal cation, ammonium, imidazolium, pyridinium, phosphonium, sulfonium or sulfoxonium.

2. The adhesive composition according to claim 1, wherein Y+ is an alkaline metal cation.

3. The adhesive composition according to claim 1, wherein Y+ is ammonium, imidazolium.

4. The adhesive composition according to claim 1, wherein Y+ is pyridinium.

5. The adhesive composition according to claim 1, wherein Y+ is phosphonium.

6. The adhesive composition according to claim 1, wherein Y+ is sulfonium.

7. The adhesive composition according to claim 1, wherein Y+ is sulfoxonium.

8. The adhesive composition according to claim 1, wherein the ionic antistatic agent represented by Formula 1 is at least one selected from a group consisting of Formulae 2 to 10 below:

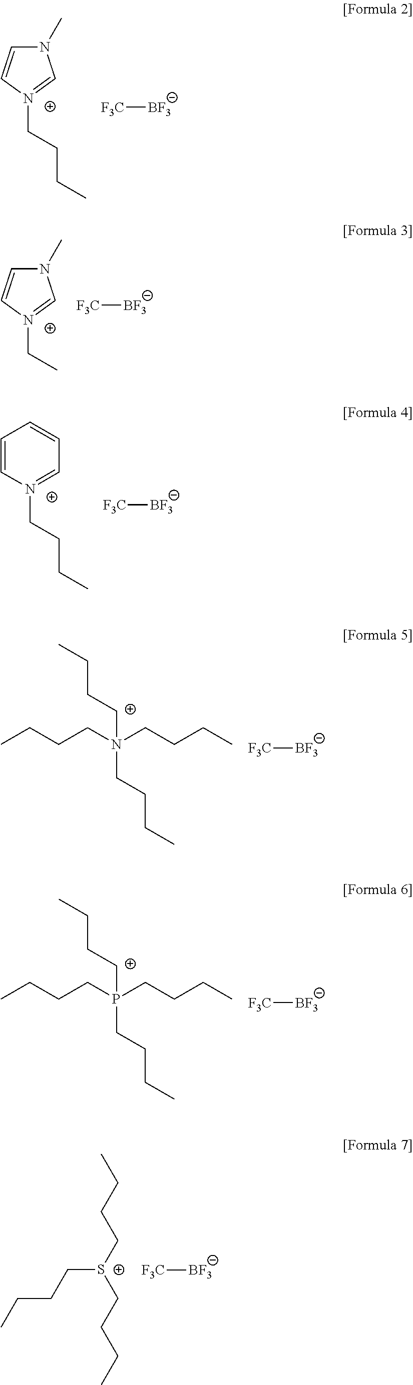

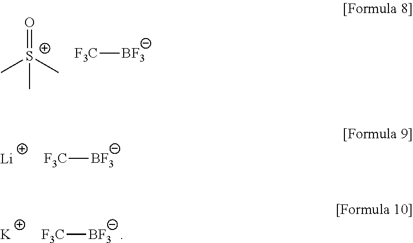

9. The adhesive composition according to claim 8, wherein the ionic antistatic agent represented by Formula 1 is at least one selected from a group consisting of Formulae 2 to 6 below:

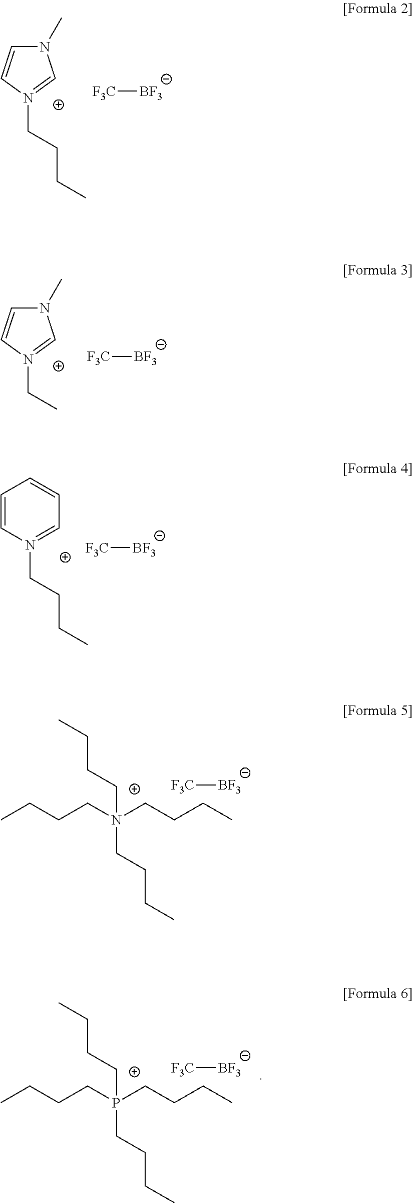

10. The adhesive composition according to claim 8, wherein the ionic antistatic agent represented by Formula 1 is at least one selected from a group consisting of Formulae 7 to 10 below:

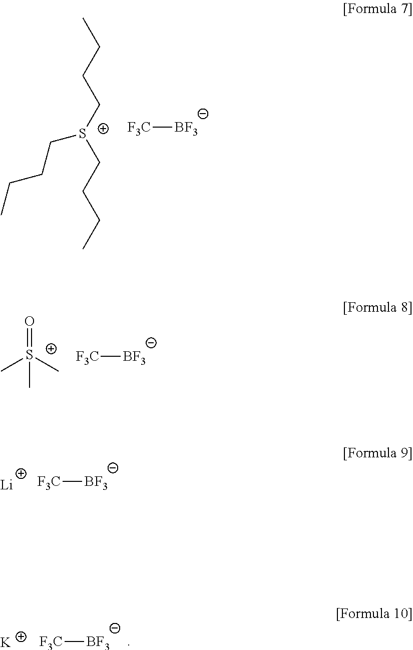

11. The adhesive composition according to claim 1, wherein the ionic antistatic agent is included in an amount of 0.1 to 10 parts by weight to 100 parts by weight of the acryl copolymer in terms of solid content.

12. The adhesive composition according to claim 1, wherein the ionic antistatic agent is included in an amount of 0.5 to 5 parts by weight to 100 parts by weight of the acryl copolymer in terms of solid content.

13. An adhesive sheet comprising an adhesive layer formed of the adhesive composition according to claim 1.

14. A polarizing plate comprising an adhesive layer formed of the adhesive composition according to claim 1 on at least one surface thereof.

15. An image display device comprising the polarizing plate according to claim 14.
